(19) United States
(12) Patent Application Publication
(10) Pub. No.: US 2025/0351160 A1
(43) Pub. Date: Nov. 13, 2025

(54) PHYSICAL SIDELINK FEEDBACK CHANNEL PRIORITIZATION

(71) Applicant: QUALCOMM Incorporated, San Diego, CA (US)

(72) Inventors: Shijun WU, San Diego, CA (US); Gene Wesley MARSH, San Diego, CA (US); Tien Viet NGUYEN, Bridgewater, NJ (US)

(21) Appl. No.: 18/658,516

(22) Filed: May 8, 2024

(51) Int. Cl. H04W 72/40; H04L 5/00; H04W 72/563

(52) U.S. Cl. CPC H04W 72/40; H04L 5/0053; H04W 72/563

(57) ABSTRACT

Various aspects of the present disclosure generally relate to wireless communication. In some aspects, a receive user equipment (UE) may receive a transmission from a transmit UE. The UE may transmit a sidelink communication selectively and based at least in part on a sidelink inter-channel prioritization rule. Numerous other aspects are described.

### FIELD OF THE DISCLOSURE

Aspects of the present disclosure generally relate to wireless communication and specifically relate to techniques, apparatuses, and methods for physical sidelink feedback channel prioritization.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a receive user equipment (UE). The method may include receiving a transmission from a transmit UE. The method may include transmitting a sidelink communication selectively and based at least in part on a sidelink inter-channel prioritization rule.

Some aspects described herein relate to an apparatus for wireless communication at a receive UE. The apparatus may include one or more memories and one or more processors coupled to the one or more memories. The one or more processors may be configured to receive a transmission from a transmit UE. The one or more processors may be configured to transmit a sidelink communication selectively and based at least in part on a sidelink inter-channel prioritization rule.

Some aspects described herein relate to a non-transitory computer-readable medium that stores a set of instructions for wireless communication by a receive UE. The set of instructions, when executed by one or more processors of the UE, may cause the UE to receive a transmission from a transmit UE. The set of instructions, when executed by one or more processors of the UE, may cause the UE to transmit a sidelink communication selectively and based at least in part on a sidelink inter-channel prioritization rule.

Some aspects described herein relate to an apparatus for wireless communication. The apparatus may include means for receiving a transmission from a transmit UE. The apparatus may include means for transmitting a sidelink communication selectively and based at least in part on a sidelink inter-channel prioritization rule.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antennas, RF-chains, power amplifiers, modulators, buffers, processor(s), interleavers, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of a hybrid automatic repeat request process, in accordance with the present disclosure.

FIG. 7 is a diagram illustrating an example of a wireless communication process between a transmit UE and a receive UE, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A communication standard may specify one or more sidelink access conditions that govern the use of sidelink air interface resources, and the one or more sidelink access conditions may be configured to provide each user equipment (UE) with commensurate and/or optimal sidelink configurations that may increase data throughput, decrease data transfer latencies, and/or reduce recovery errors in a manner that enables the UE to comply with regulations. For instance, a vehicle-to-everything (V2X) sidelink access condition may be based at least in part on a regional regulation and/or regional intelligent transport systems (ITS) frequency band that differs from a cellular coverage frequency band. As one example, a sidelink access condition may govern access and/or use of a sidelink air interface resource based at least in part on a duty cycle of sidelink transmissions by the UE.

A duty cycle of transmissions by a UE may scale and/or increase based at least in part on increased transmissions, additional retransmissions, and/or sidelink feedback transmissions (e.g., a physical sidelink feedback channel (PSFCH) transmission). In some aspects, a PSFCH transmission may consume a larger portion of an allowed duty cycle relative to sidelink data transmissions (e.g., a physical sidelink shared channel (PSSCH) transmission), leading to decreased availability of resources for data transmissions as described below. Alternatively, or additionally, a UE communicating via a sidelink may operate as a receive UE more than a transmit UE to mitigate missing sidelink transmissions by other UEs such that the number of sidelink feedback transmissions by the UE may increase proportionally with an amount of time the UE operates as a receive UE. The increased number of sidelink feedback transmissions may consume a majority of an allowed duty cycle, resulting in fewer resources being available for sidelink data transmissions (e.g., PSSCH transmissions), dropped sidelink data transmissions, reduced data throughput, and/or increased data transfer latencies in sidelink communications.

Various aspects relate generally to PSFCH prioritization. Some aspects more specifically relate to a UE prioritizing sidelink transmissions using a sidelink inter-channel prioritization rule. In some aspects, a receive UE may receive a transmission from a transmit UE, and may selectively transmit a sidelink communication based at least in part on a sidelink inter-channel prioritization rule. As one example, the sidelink inter-channel prioritization rule may indicate that a PSSCH and/or a PSSCH transmission has priority over a PSFCH and/or a PSFCH transmission. Accordingly, based at least in part on the sidelink inter-channel prioritization, the receive UE may drop transmission of a PSFCH communication and/or may transmit a PSSCH transmission.

Particular aspects of the subject matter described in this disclosure can be implemented to realize one or more of the following potential advantages. In some examples, by selectively transmitting a sidelink communication based at least in part on a sidelink inter-channel prioritization, the described techniques can be used to enable a receive UE to satisfy a sidelink access condition, such as duty cycle condition, in a manner that reduces data transfer latencies and/or increases data throughput in sidelink communications.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

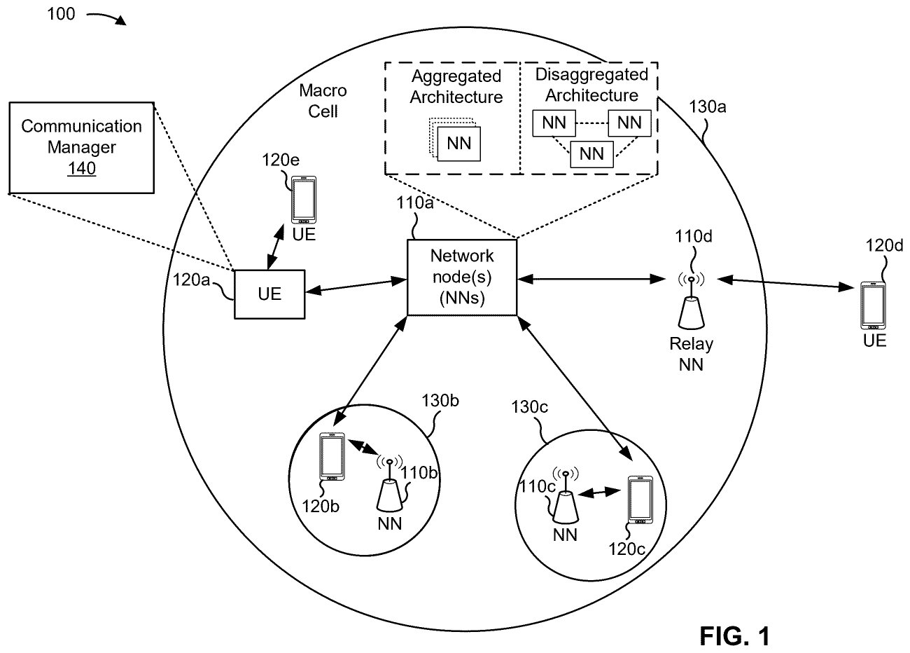

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHz, FRI is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, collaborate, or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive a transmission from a transmit UE; and transmit a sidelink communication selectively and based at least in part on a sidelink inter-channel prioritization rule. Additionally, or alternatively, the communication manager 140 may perform one or more other operations described herein.

As indicated above, FIG. 1 is provided as an example. Other examples may differ from what is described with regard to FIG. 1.

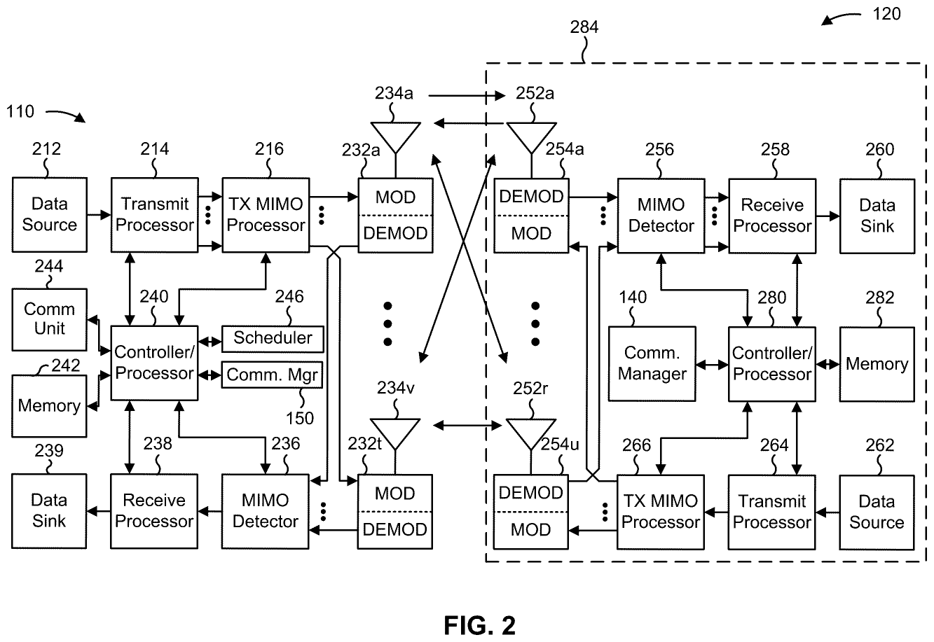

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a PSSCH, a physical sidelink control channel (PSCCH), and/or a PSFCH.

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

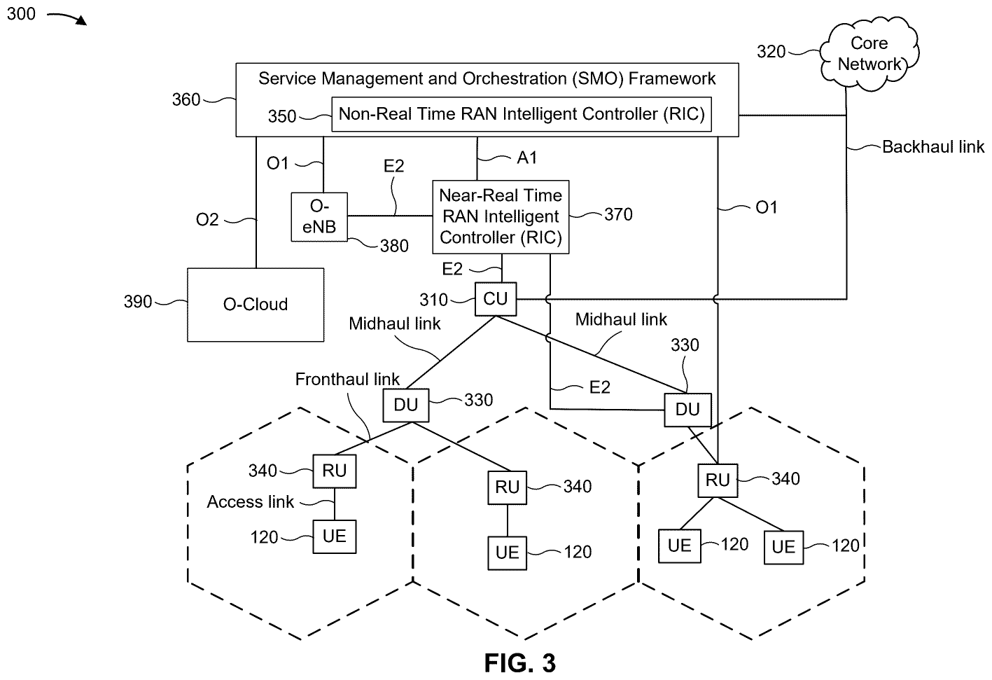

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

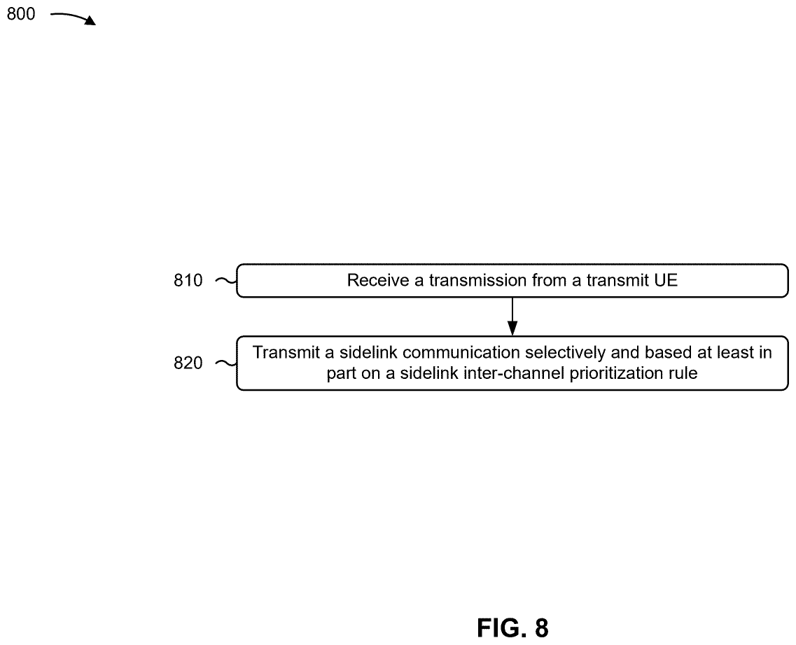

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with PSFCH prioritization, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, or other processes as described herein. In some examples, executing instructions may include running the instructions, converting the instructions, compiling the instructions, and/or interpreting the instructions, among other examples.

In some aspects, a receive UE (e.g., a UE 120) includes means for receiving a transmission from a transmit UE; and/or means for transmitting a sidelink communication selectively and based at least in part on a sidelink inter-channel prioritization rule. The means for the receive UE to perform operations described herein may include, for example, one or more of communication manager 140, antenna 252, modem 254, MIMO detector 256, receive processor 258, transmit processor 264, TX MIMO processor 266, controller/processor 280, or memory 282.

As indicated above, FIG. 3 is provided as an example. Other examples may differ from what is described with regard to FIG. 3.

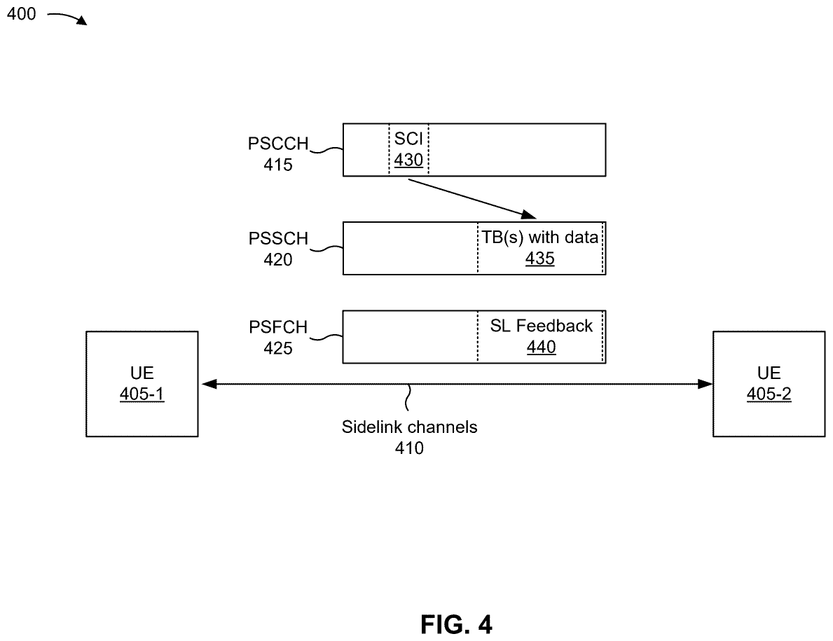

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a PSSCH 420, and/or a PSFCH 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement (ACK) or negative acknowledgement (NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 420, such as HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in DCI) or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or a modulation and coding scheme (MCS) to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

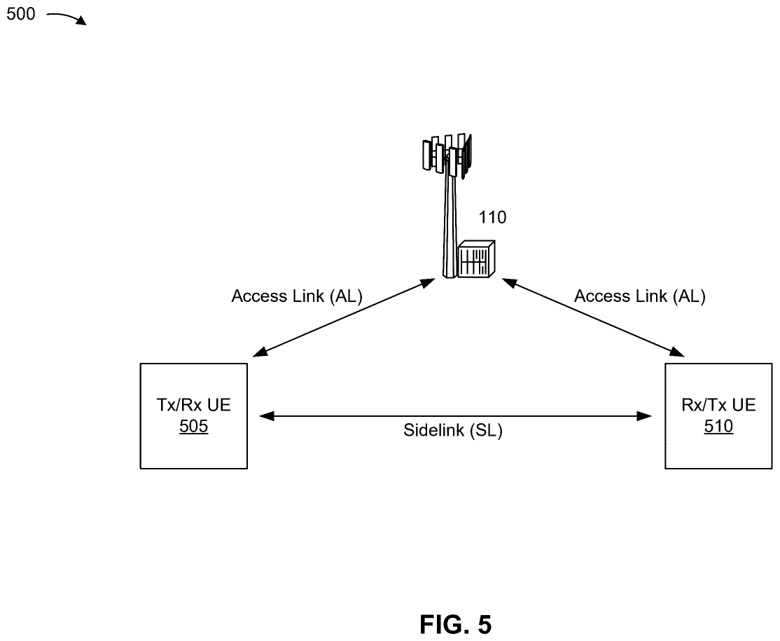

FIG. 5 is a diagram illustrating an example 500 of sidelink communications and access link communications, in accordance with the present disclosure.

As shown in FIG. 5, a Tx/Rx UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

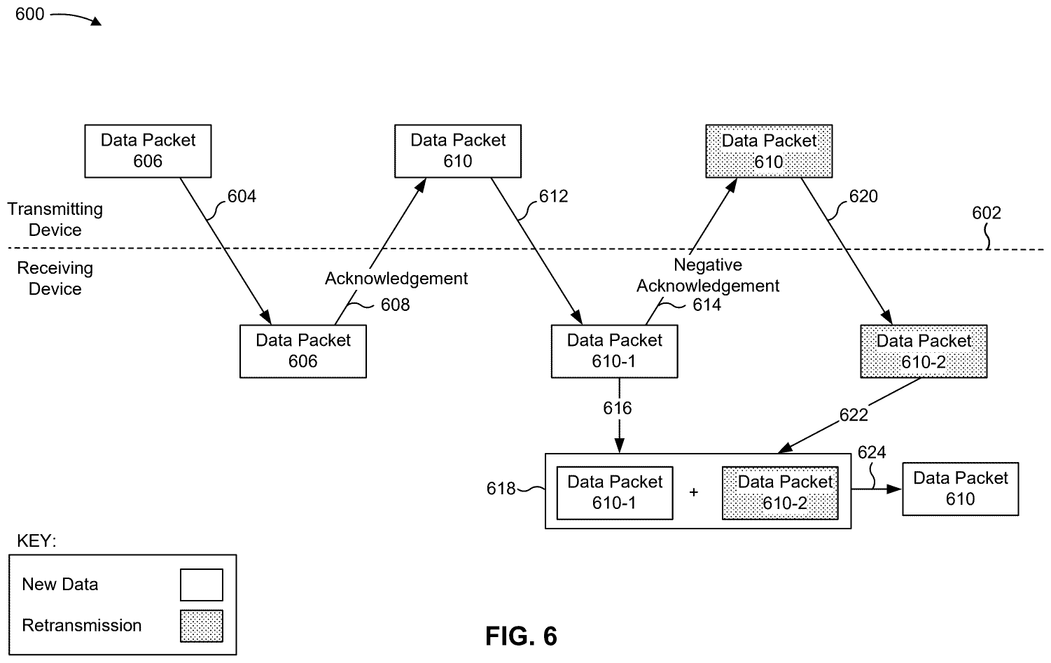

FIG. 6 is a diagram illustrating an example 600 of a HARQ process, in accordance with the present disclosure.

A MAC layer of a protocol stack may implement a HARQ protocol to provide a faster retransmission mechanism relative to other retransmission mechanisms, such as a radio link control (RLC) layer retransmission system. In some aspects, the HARQ protocol may include a transmitting device using a retransmission protocol in combination with a receiving device, such as a send and wait (SAW) protocol that enables the receiving device to recover and/or correct data errors in a first HARQ process without hindering data transmissions in a second HARQ process. Accordingly, multiple HARQ processes may operate in parallel, and data errors identified in the first HARQ process may not hinder transmissions in the second HARQ process. Some non-limiting examples of transmitting device-receiving device pairs that may implement a HARQ process in combination may include a network node 110 and a UE 120 (e.g., a downlink HARQ process), a UE 120 and a network node 110 (e.g., an uplink HARQ process), and/or a first UE 120 and a second UE 120 (e.g., a sidelink HARQ process).

Thus, a HARQ process may be used for downlink communications, uplink communications, and/or sidelink communications. In some aspects, and as part of a HARQ process, a network node may transmit information in DCI that indicates to a receiving device (e.g., a UE 120) which downlink transmission(s) and/or which uplink transmissions to process using a HARQ protocol. Alternatively, or additionally, and as part of the HARQ process, a first UE may transmit information in SCI that indicates, to a second UE, which sidelink transmission(s) to process using the HARQ protocol.

In some aspects, a HARQ process and/or HARQ protocol may enable a receiving device to correct errors in a received data packet, such as by correcting errors within a TB based at least in part on soft combining packets in a physical (PHY) layer as described below. In some aspects, a TB may be partitioned into one or more code block groups (CBGs), and each CBG may partitioned into one or more code blocks (CBs) as described with regard to FIG. 5. To correct for errors, the receiving device may buffer one or more data packets that have been identified as including an error, combine the data packets, and process the combined data packets to reduce errors. In some aspects, “codeword (CW)” may refer to a TB that includes error protection, and a transmission may include multiple CWs.

The example 600 includes transactions between a transmitting device and a receiving device. Transactions and/or data located above dashed line 602 are performed by, and/or reside at, a transmitting device (e.g., a network node 110 for a downlink HARQ process, a UE 120 for an uplink HARQ process, and/or a first UE 120 for a sidelink HARQ process). Transactions and/or data located below the dashed line 602 are performed by, and/or reside at, a receiving device (e.g., a UE 120 for a downlink HARQ process, a network node 110 for an uplink HARQ process, and/or a second UE 120 for a sidelink HARQ process). As shown by reference number 604, the transmitting device may transmit a first data packet 606 that is a new transmission of data that is included in the first data packet 606 (e.g., a first transmission of the data, shown through the use of solid white). In some aspects, the transmitting device may buffer and/or store the first data packet 606 as part of a HARQ process until receiving an indication from the receiving device that the first data packet 606 has been received and/or recovered with minimal errors (e.g., error-free and/or a number of errors that satisfy a low threshold). Based at least in part on receiving the first data packet 606 with minimal errors, the receiving device may transmit an acknowledgement (ACK) to the transmitting device as shown by reference number 608, such as a HARQ acknowledgement. The receiving device may validate the first data packet 606 using any suitable error detection mechanism, such as a cyclic redundancy check (CRC) process that validates the received data by computing a CRC value using the received data and comparing the computed CRC value(s) to a CRC value included with the received data.

Based at least in part receiving the ACK, the transmitting device may transmit a second data packet 610 as shown by reference number 612, and the second data packet 610 may be a new transmission of data (e.g., different data than the data included in the first data packet 606). In a similar manner as the first data packet 606, the transmitting device may store the second data packet 610 in the buffer and/or remove the first data packet 606 from the buffer. In some aspects, the receiving device may not receive the second data packet 610 successfully, shown in FIG. 6 as data packet 610-1. For example, the receiving device may identify that the data packet 610-1 was received with a number of errors that fail to satisfy the low error threshold. Accordingly, and as shown by reference number 614, the receiving device may transmit a negative acknowledgement (NACK) to indicate that the second data packet 610 was received with errors and/or unsuccessfully. Alternatively, or additionally, the receiving device may transmit the NACK to indicate a request for a retransmission of the second data packet 610. In some aspects, and as shown by reference number 616, the receiving device may store the data packet 610-1 in a buffer 618.

Based at least in part on receiving the NACK, and as shown by reference number 620, the transmitting device may retransmit the second data packet 610 to the receiving device, where the retransmission is shown by FIG. 6 through the use of a dotted pattern. The receiving device may receive the retransmission of the second data packet 610 (shown as data packet 610-2), and, as shown by reference number 622, the receiving device may store the data packet 610-2 in the buffer 618 and/or may combine the data packet 610-1 with the data packet 610-2. As one example, the receiving device may combine the data packet 610-1 and the data packet 610-2 prior to channel decoding and/or error detection, and may process the combined data packet to mitigate errors as shown by reference number 624. That is, by processing the combined data packet, the receiving device may recover data that includes minimal errors (e.g., is error-free and/or includes a number of errors that satisfy the low error threshold). In some aspects, the receiving may combine the data packet 610-1 and the data packet 610-2 using soft combining. “Soft combining” may denote combining multiple received signals based at least in part on a confidence and/or reliability of each received signal, such as by combining received signals using a log likelihood ratio (LLR), to improve a signal quality of the combined data packet and reduce recovery errors.

In some aspects, the receiving device may transmit an ACK to the transmitting device, such as in scenarios that the receiving device is able to recover a version of the second data packet 610 that includes minimal errors. In other aspects, the receiving device may transmit a NACK to the transmitting device, such as in scenarios that the receiving device is unable to recover a version of the second data packet 610 with minimal errors.

A HARQ process may be used to regulate any combination of PDSCH transmissions, PUSCH transmissions, and/or PSSCH transmissions. Accordingly, the first data packet 606 and/or the second data packet 610 shown by FIG. 6 may be based at least in part on one or more PDSCH transmissions, one or more PUSCH transmissions, and/or one or more PSSCH transmissions. For PDSCH transmissions, the receiving device (e.g., a UE 120) may transmit ACK/NACK feedback via PUCCH or PUSCH. For PUSCH transmission, the receiving device (e.g., a network node 110) may transmit ACK/NACK feedback in an uplink grant (e.g., indicated via DCI). For a sidelink transmission, the receiving device (e.g., a UE 120) may transmit ACK/ACK feedback via a PSFCH.

Sidelink HARQ feedback transmitted by a receive UE may be configured in multiple ways. In a first example, a transmit UE may transmit data to a receive UE, and the receive UE may transmit an ACK or a NACK (ACK/NACK) to indicate whether the data was successfully received (e.g., an ACK) or unsuccessfully received (e.g., a NACK). Sidelink HARQ feedback that includes transmission of an ACK message or a NACK message may be referred to as sidelink ACK/NACK feedback. In a second example, the sidelink HARQ feedback may be configured based at least in part on a transmission type of a communication from a transmit UE (e.g., a unicast transmission type and/or a groupcast message type). To illustrate, a transmit UE may transmit a unicast sidelink transmission (e.g., a unicast PSSCH transmission) to a receive UE, and the receive UE may transmit sidelink ACK/NACK feedback to indicate whether the unicast sidelink transmission was successfully and/or unsuccessfully decoded. Accordingly, the sidelink HARQ feedback for a unicast sidelink transmission may be configured as sidelink ACK/NACK feedback.

In another scenario, the transmit UE may transmit a groupcast sidelink transmission (e.g., a groupcast PSSCH transmission) that is directed to a group of UEs, and the sidelink HARQ feedback transmitted by each respective receive UE in the group of UEs may be configured as one of at least two options. As a first option, a UE in a group of UEs may transmit a NACK based at least in part on unsuccessful decoding of the group sidelink transmission, and may not transmit any sidelink feedback (e.g., may not transmit an ACK) based at least in part on successful decoding of the groupcast sidelink transmission. That is, a receive UE may only transmit a NACK to indicate unsuccessful decoding of the groupcast sidelink transmission. The transmission of only NACK feedback and not ACK feedback may be referred to as sidelink NACK feedback. As a second option, each receive UE in the group of UEs may transmit, as the sidelink HARQ feedback, sidelink ACK/NACK feedback that indicates whether the groupcast sidelink transmission was successfully or unsuccessfully decoded.

Sidelink HARQ feedback resources (e.g., a PSFCH resource) may be accessed by multiple UEs. To illustrate, a same sidelink HARQ feedback resource may be used by each UE in the group of UEs to indicate sidelink HARQ feedback for a groupcast sidelink transmission, such as a groupcast PSSCH transmission. Alternatively, or additionally, a UE (e.g., a transmit UE and/or a receive UE) may transmit a conflict indication using a sidelink HARQ feedback resource. In some aspects, a conflict indication may indicate that a sidelink resource reservation of the UE is colliding and/or is scheduled to collide with another UE's sidelink resource reservation. The conflict indication may alternatively be referred to as inter-UE coordination conflict information.

In some aspects, a communication standard may specify one or more sidelink access conditions that govern the use of sidelink air interface resource(s), and the sidelink access condition(s) may be configured to provide each UE with commensurate (e.g., within a threshold) and/or optimal sidelink configurations (e.g., increase data throughput, decrease data transfer latencies, and/or reduce recovery errors) and result in the UE complying with regulations. For instance, a V2X sidelink access condition may be based at least in part on a regional regulation and/or ITS frequency band that differs from a cellular coverage frequency band. As an example, a sidelink access condition (e.g., regional and/or non-regional) may govern access and/or use of a sidelink air interface resource based at least in part on a subchannel size, a transmission power, and/or an SCI configuration. Alternatively, or additionally, a sidelink access condition may govern access and/or use of a sidelink air interface resource based at least in part on a duty cycle of sidelink transmission(s) (e.g., V2X transmissions) by a UE.

To illustrate, a sidelink access condition for V2X sidelink transmissions may specify a maximum ratio of time resources that a UE may use and/or occupy, such as a 3% duty cycle and/or a 6% duty cycle. In at least one scenario, a slot that includes 14 OFDM symbols may have a 0.5 millisecond (msec) duration for 30 kHz subcarrier spacing. An example duty cycle calculation for a periodic PSSCH transmission that has a 100 millisecond (msec) period and occupies 13 OFDM symbols of the 14 OFDM symbol slot is as follows:

$$duty cycle = \frac{13}{14} \times \frac{0.5}{100} = 0.46 \%$$

A duty cycle of transmissions by a UE may scale and/or increase based at least in part on increased transmissions, additional retransmissions, and/or sidelink HARQ feedback transmissions (e.g., a PSFCH transmission). To illustrate, an example sidelink HARQ feedback transmission may contribute to the duty cycle in the above scenario as follows:

$$duty cycle = \frac{2}{14} \times \frac{0.5}{100} = 0.071 \%$$

In some aspects, a PSFCH transmission (e.g., sidelink HARQ feedback and/or inter-UE coordination conflict information) may consume a larger portion of an allowed duty cycle (e.g., specified by a sidelink access condition) relative to sidelink data transmissions (e.g., a PSSCH transmission), resulting in decreased availability of resources for data transmissions. Alternatively, or additionally, a UE communicating via a sidelink (e.g., a V2X UE) may operate as a receive UE more than a transmit UE to mitigate missing sidelink transmissions by other UEs. For instance, the UE may operate as a receive UE for 90-95% of an operating time, and for 5-10% of the operating time as a transmit UE. Operating as a receive UE more than a transmit UE may increase a number of sidelink HARQ feedback transmissions (e.g., either NACK-only sidelink HARQ feedback transmissions and/or ACK/NACK sidelink HARQ feedback transmissions as described above) by the UE, and the increased number of sidelink HARQ feedback transmissions may consume a majority of an allowed duty cycle. To illustrate, in an example scenario, a receive UE may detect sidelink transmissions in 60% of time resources in a time window and may transmit sidelink HARQ feedback for half of the detected sidelink transmissions. For a PSFCH sidelink resource configuration that has a periodicity of 2 slots (e.g., every other slot includes a PSFCH sidelink resource), a duty cycle of the sidelink HARQ feedback transmissions may be calculated as follows:

$$sidelink HARQ feedback duty cycle = \frac{0.6}{2} \times \frac{2}{14} \times 0.5 = 2.1 \%$$

For a sidelink access condition that is based at least in part on a duty cycle such as 3% or 6%, sidelink HARQ feedback may consume a substantial portion (e.g., at least more than 30%) of the duty cycle. The addition of a conflict indication (e.g., inter-UE coordination conflict information) that uses a PSFCH resource may increase the portion of duty cycle that is used by PSFCH transmissions, resulting in reduced and/or dropped sidelink data transmissions (e.g., PSSCH transmissions), reduced data throughput, and/or increased data transfer latencies in sidelink communications. To illustrate, the UE may drop a PSSCH transmission to meet a sidelink access condition that is based at least in part on a duty cycle.

Some techniques and apparatuses described herein provide PSFCH prioritization. In some aspects, a receive UE may receive a transmission from a transmit UE, and may selectively transmit a sidelink communication based at least in part on a sidelink inter-channel prioritization rule. As one example, the sidelink inter-channel prioritization rule may indicate that a PSSCH and/or a PSSCH transmission has priority over a PSFCH and/or a PSFCH transmission. Accordingly, based at least in part on the sidelink inter-channel prioritization, the receive UE may drop transmission of a PSFCH communication and/or may transmit a PSSCH transmission. By selectively transmitting a sidelink communication (e.g., dropping transmission of a PSFCH communication or transmitting a PSSCH transmission) based at least in part on a sidelink inter-channel prioritization, a receive UE may satisfy a sidelink access condition, such as a duty cycle condition, in a manner that reduces data transfer latencies and/or increases data throughput in sidelink communications.

As indicated above, FIG. 6 is provided as an example. Other examples may differ from what is described with regard to FIG. 6.

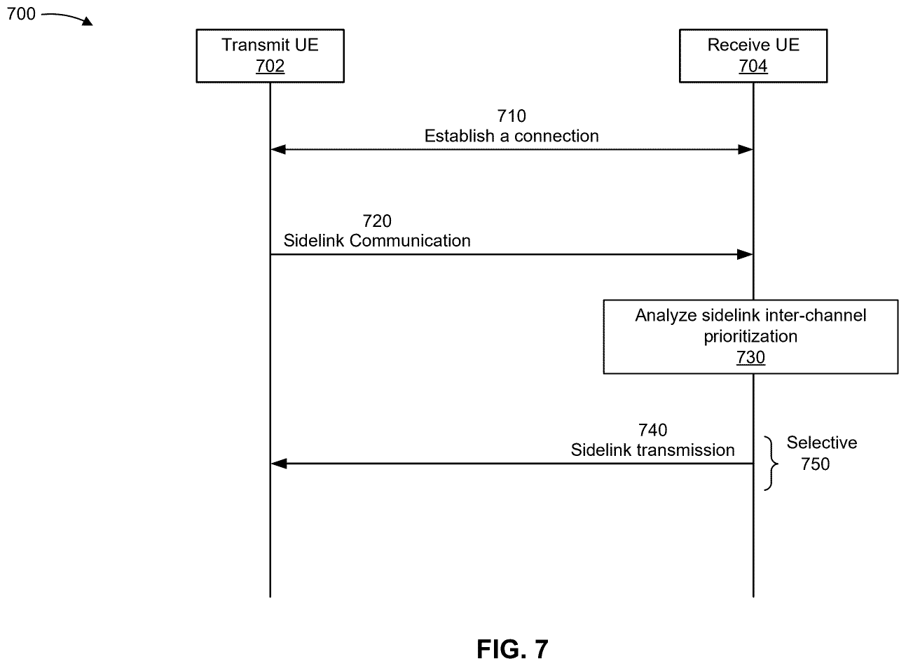

FIG. 7 is a diagram illustrating an example 700 of a wireless communication process between a transmit UE 702 (e.g., a first UE 120) and a receive UE 704 (e.g., a second UE 120), in accordance with the present disclosure. For clarity, the transmit UE 702 is labeled as a transmit UE, and the receive UE 704 is labeled as a receive UE, based at least in part on a sidelink HARQ process, but the transmit UE 702 may receive communications that are transmitted by the receive UE 704. Alternatively, or additionally, the transmit UE 702 may operate as another receive UE for a second HARQ process and/or the receive UE 704 may operate as another transmit UE for the second HARQ process.

As shown by reference number 710, a transmit UE 702 and a receive UE 704 may establish a sidelink. To illustrate, the transmit UE 702 may change to a location that is within an operating range of the receive UE 704 (or vice versa), and the transmit UE 702 and the receive UE 704 may establish a sidelink with one another. The transmit UE 702 and the receive UE 704 may communicate via the sidelink based at least in part on any combination of Layer 1 signaling (e.g., SCI), Layer 2 signaling (e.g., a MAC CE), and/or Layer 3 signaling (e.g., RRC signaling). To illustrate, the transmit UE 702 may request, via RRC signaling, UE capability information and/or the receive UE 704 may transmit, via RRC signaling, the UE capability information. As part of communicating via the connection, the transmit UE 702 may transmit configuration information via Layer 3 signaling (e.g., RRC signaling), and activate and/or deactivate a particular configuration via Layer 2 signaling (e.g., a MAC CE) and/or Layer 1 signaling (e.g., SCI). To illustrate, the transmit UE 702 may transmit the configuration information via Layer 3 signaling at a first point in time associated with the receive UE 704 being tolerant of communication delays, and the transmit UE 702 may transmit an activation of the configuration via Layer 2 signaling and/or Layer 1 signaling at a second point in time associated with the receive UE 704 being intolerant to communication delays. While the example 700 includes the transmit UE 702 establishing a sidelink connection with the receive UE 704, other examples may not include the transmit UE 702 and the receive UE 704 establishing a sidelink connection. For example, the transmit UE 702 may broadcast and/or groupcast a transmission without establishing a sidelink connection with the receive UE 704.

As shown by reference number 720, the transmit UE 702 may transmit, and the receive UE 704 may receive, a sidelink communication. As one example, the transmit UE 704 may transmit a data communication using a PSSCH and/or using a sidelink. In other examples, the transmit UE 702 may broadcast and/or groupcast a transmission that is received by the receive UE 704 without the use of an established sidelink connection.

As shown by reference number 730, the receive UE 704 may analyze a sidelink inter-channel prioritization rule. For example, the receive UE 704 may compute a current duty cycle of the receive UE 704 and/or a current resource consumption. In some aspects, the receive UE 704 may compare the current duty cycle and/or the current resource consumption to a duty cycle threshold and/or a duty cycle resource threshold, respectively, that are based at least in part on a sidelink access condition, such as a maximum allowed duty cycle and/or a maximum allowed number of sidelink resources indicated by the sidelink access condition. Accordingly, the receive UE 704 may determine whether the current duty cycle and/or the current resource consumption satisfies a sidelink access condition based at least in part on whether the current duty cycle and/or the current resource consumption satisfy, or fail to satisfy, the respective thresholds. Alternatively, or additionally, the receive UE 704 may analyze the inter-prioritization rule based at least in part on having multiple sidelink communications to transmit in order to determine which sidelink communication(s) to transmit and/or which sidelink communication(s) to drop (e.g., not transmit).

As one example, the sidelink inter-channel prioritization rule may indicate a relative priority between a first sidelink channel and a second sidelink channel, such as a relative priority between a PSFCH and a PSSCH. As an example, the sidelink inter-channel prioritization rule may indicate that the PSSCH has priority over the PSFCH, or vice versa. The receive UE 704 may consequently prioritize a first sidelink transmission that is linked to the higher priority sidelink channel over a second sidelink transmission that is linked to the lower priority sidelink channel.

Alternatively, or additionally, the sidelink inter-channel prioritization rule may indicate a relative priority between sidelink feedback communication types, such as a prioritization that indicates that a sidelink NACK feedback communication has a higher priority than a sidelink ACK/NACK feedback communication (or vice versa) and/or a prioritization that indicates that a PSSCH communication has higher priority than inter-UE coordination conflict information (or vice versa). Alternatively, or additionally, the sidelink inter-channel prioritization rule may indicate that the inter-UE coordination conflict information has a lower priority than the PSSCH communication (or vice versa). In some aspects, the PSSCH may have an absolute priority over the PSFCH such that the receive UE 704 determines to always prioritize PSSCH over PSFCH (e.g., by prioritizing a PSSCH transmission over a PSFCH transmission) such that the receive UE 704 will always drop a PSFCH transmission (e.g., a sidelink feedback communication and/or inter-UE coordination information) instead of a PSSCH transmission in a scenario that includes the receive UE 704 dropping a transmission to meet a sidelink access condition.

Alternatively, or additionally, the sidelink inter-channel prioritization rule may indicate a dropping rule that is based at least in part on a prioritization between different priorities (e.g., transmission dropping based on priority) and/or priority types (e.g., a transmission occasion priority, a sidelink channel priority, and/or a sidelink communication priority). As one example of a sidelink communication priority, a transmission may have an associated priority that is indicated via a priority field in SCI and/or PSCCH. For instance, the priority field may include three (3) bits that are used to indicate one (1) of eight (8) different priority values/levels that is assigned to the transmission. A UE may receive multiple transmissions in a single slot (e.g., carried in multiple sub-channels), and each transmission may be assigned a respective priority level or value indicated by a priority field, and a sidelink inter-channel prioritization rule (e.g., for dropping and/or not dropping a transmission) may be based at least in part on the sidelink communication priority.

As an example of a transmission occasion priority, a first transmission occasion (e.g., slots) may be associated with (e.g., designated for) a PSSCH transmission and a second transmission occasion may be associated with a PSFCH transmission, and each transmission occasion may be assigned a respective transmission occasion priority. To illustrate, the first transmission occasion associated with a PSSCH transmission occasion may have a higher priority relative to the second transmission occasion associated with the PSFCH transmission. Accordingly, sidelink transmission occasions may be assigned and/or associated with a respective priority (e.g., a transmission occasion priority), and the sidelink inter-channel prioritization rule may indicate to drop a sidelink communication that is linked to a first sidelink transmission occasion that has a lower priority relative to a second sidelink transmission occasion. That is, a sidelink inter-channel prioritization rule (e.g., for dropping and/or not dropping a transmission) may be based at least in part on a transmission occasion priority.

In some aspects, a sidelink channel may be assigned and/or associated with a priority of a respective transmission occasion. For instance, a PSSCH may be assigned and/or associated with a priority of the transmission occasion that is allotted for the PSSCH. Alternatively, or additionally, a transmission occasion may be assigned and/or associated with a priority of a sidelink channel communication and/or sidelink channel transmission. To illustrate, a group of PSFCH transmissions and/or PSFCH communications may be associated with a same transmission occasion, and a priority of the transmission occasion may be based at least in part on a priority of the PSFCH transmission and/or PSFCH communication with the highest priority within the group.

In some aspects, a sidelink inter-channel prioritization rule may indicate a dropping rule (e.g., a priority of which sidelink transmission to drop and/or a priority of which transmission occasion to not use) that is configured to enable the receive UE 704 to satisfy a duty cycle condition by indicating to drop a first sidelink transmission in favor of transmitting a second sidelink transmission. Alternatively, or additionally, the dropping rule may be conditional on a current state of the receive UE 704. For instance, the dropping rule may specify to not drop a sidelink transmission based at least in part on a current duty cycle of the receive UE 704 satisfying a low duty cycle threshold (e.g., the current duty cycle is below an allowed duty cycle) and/or may specify to drop the sidelink transmission based at least in part on the current duty cycle of the receive UE 704 failing to satisfy a low duty cycle threshold (e.g., the current duty cycle is approaching the allowed duty cycle). While the above example described a duty cycle threshold, the dropping rule may be based at least in part on other types of thresholds, such as a resource threshold. To illustrate, the receive UE 704 may analyze the sidelink inter-channel prioritization rule and/or may determine whether to use a dropping rule indicated by the sidelink inter-channel prioritization rule based at least in part on a current resource consumption satisfying a duty cycle resource threshold within a time window. In some aspects, the duty cycle resource may be based at least in part on a total number of sidelink resources that satisfy a duty cycle condition (e.g., an allowed duty cycle) and/or a fewer number of sidelink resources than the total number of sidelink resources, to mitigate reaching the allowed duty cycle. As one example, a sidelink access condition may specify a 6% duty cycle as an allowed duty cycle for a sidelink access condition, and the receive UE 704 may use a duty cycle threshold and/or a duty cycle resource threshold that is based at least in part on a lower duty cycle, such as a 5% duty cycle.

The receive UE 704 may compute a current number of sidelink resources that are used by the receive UE 704 within a time window (e.g., a 100 msec time window), where the current number of sidelink resources may be reset to zero at the start of each time window. In some aspects, the receive UE 704 may iteratively compute and/or compare the current number of sidelink resources to a duty cycle resource threshold during the time window to determine whether and/or when to begin dropping lower priority sidelink transmissions and/or all PSFCH transmissions in a remaining duration of the time window as described below. That is, the receive UE 704 may use the current number of sidelink resources and/or an accumulated number of sidelink resources to calculate an accumulated duty cycle within a time window and/or may determine when to start dropping one or more sidelink transmissions to satisfy an allowed duty cycle.

Alternatively, or additionally, a sidelink inter-channel prioritization rule may indicate a priority threshold, and the receive UE 704 may use the priority threshold to selectively transmit (e.g., transmit or drop) a sidelink communication. That is, the receive UE 704 may drop transmission of one or more sidelink communications that have a respective priority that fails to satisfy the priority threshold. To illustrate, the receive UE 704 may have a group of sidelink communications to transmit. During a particular time window, the receive UE 704 may transmit all sidelink communications within the group that have a respective priority that satisfies the priority threshold and/or may drop all sidelink communications within the group that have a respective priority that fails to satisfy the priority threshold (e.g., during a time window). At a restart of a time window, the receive UE 704 may resume transmitting sidelink communications that were dropped in a prior time window. Alternatively, or additionally, the receive UE 704 may begin dropping sidelink communication(s) based on the priority threshold at a point in time within the time window that is associated with a duty cycle resource threshold being satisfied as described above.

As at least part of analyzing a sidelink inter-channel prioritization rule, the receive UE 704 may compare the priority threshold to a transmission occasion priority. To illustrate, the receive UE 704 may analyze one or more transmission occasion priorities, such as by analyzing the respective priorities of multiple PSFCH transmission occasions, and may determine to drop transmission of a first PSFCH that is linked to a first PSFCH transmission occasion that has a first priority that fails to satisfy the priority threshold. Alternatively, or additionally, the receive UE 704 may determine to transmit a second PSFCH that is linked to a second PSFCH transmission occasion with a second priority that satisfies the priority threshold. In some aspects, and as described above, the receive UE 704 may be configured to transmit multiple sidelink transmissions in a same sidelink transmission occasion, such as multiple PSFCH transmissions in a same PSFCH transmission occasion. The receive UE 704 may use the highest priority of the multiple sidelink transmissions (e.g., the multiple PSFCH transmissions) as a transmission occasion priority of the sidelink transmission occasion (e.g., the PSFCH transmission occasion). The receive UE 704 may exclude some sidelink transmissions from the group of sidelink transmissions that are used to determine a transmission occasion priority (e.g., a PSFCH transmission occasion priority). To illustrate, a priority of a PSFCH transmission that includes and/or carries ACK/NACK sidelink feedback may be excluded from a group of PSFCH transmissions that the receive UE 704 evaluates for selecting a priority of a transmission occasion.

Alternatively, or additionally, and as part of analyzing the sidelink inter-channel prioritization rule, the receive UE 704 may determine to drop a transmission occasion (e.g., may not use the transmission occasion) based at least in part on the group of sidelink transmissions. For example, if each sidelink transmission in the group of sidelink transmissions is configured to carry a respective conflict indication and/or respective inter-UE coordination conflict information, the sidelink inter-channel prioritization rule may specify, and/or the UE 704 may determine, to drop and/or not use the sidelink transmission occasion.

In some aspects, the receive UE 704 may configure and/or select a priority threshold, such as by obtaining the priority threshold from memory local to the receive UE 704, while in other aspects, the sidelink inter-channel prioritization rule may specify the priority threshold. Alternatively, or additionally, the sidelink inter-channel prioritization rule may indicate, and/or the receive UE 704 may determine, to set the priority threshold to a priority of a lowest priority PSSCH transmission at the receive UE 704. Accordingly, the priority threshold may be dynamically changed at the receive UE 704 based at least in part on current PSCCH transmissions at the receive UE 704.

As shown by reference number 740, the receive UE 704 may transmit, and the transmit UE 702 may receive, a sidelink transmission and, as shown by reference number 750, the UE 704 may selectively transmit the sidelink transmission.

“Selectively transmitting” may denote transmitting or dropping a transmission based at least in part on a sidelink inter channel prioritization rule. For example, the receive UE 704 may transmit a first sidelink communication and/or drop transmission of a second sidelink communication based at least in part on a sidelink inter-channel prioritization rule that indicates a relative priority between the first sidelink communication and the second sidelink communication. To illustrate, the receive UE 704 may drop transmission of a first sidelink communication (e.g., a PSFCH) and/or may transmit a second sidelink communication, such as a PSSCH, based at least in part on a sidelink inter-channel prioritization rule indicating that the second sidelink communication has a higher transmission priority relative to the first sidelink communication and/or that the second sidelink communication has precedence for transmission over the first sidelink communication.

In some aspects, selective transmission by the receive UE 704 may be conditional. To illustrate, and as described with regard to reference number 730, the receive UE 702 may selectively transmit a sidelink communication based at least in part on a duty cycle threshold and/or a duty cycle resource threshold. In some aspects, the sidelink inter-channel prioritization rule may indicate a dropping rule that specifies to drop a sidelink communication based at least in part on a current resource consumption satisfying the duty cycle resource threshold and/or to transmit the sidelink communication based at least in part on the current resource consumption failing to satisfy the duty cycle resource threshold. Accordingly, the receive UE 704 may transmit the sidelink communication at a first point in a time window based at least in part on a current resource consumption failing to satisfy the duty cycle resource threshold or may drop transmission of the (same) sidelink communication at a second point in the time in the time window based at least in part on the current resource consumption satisfying a duty cycle resource threshold. As described above, the current resource consumption may be an accumulation of sidelink resources that are used by the receive UE 704 during a time window, may be iteratively calculated by the receive UE 704 during the time window, and/or may be reset to zero at the start of a new time window.

In some aspects, the sidelink inter-channel prioritization rule may indicate a priority threshold, and the receive UE 704 may selectively transmit (e.g., transmit or drop) a sidelink communication using the priority threshold. For example, the receive UE 704 may compare a priority of a transmission occasion for the sidelink communication to the priority threshold, and the receive UE 704 may transmit or drop the sidelink communication based at least in part on whether the transmission occasion priority satisfies the priority threshold or fails to satisfy the priority threshold, respectively. As another example, the sidelink inter-channel prioritization rule may indicate to drop a sidelink communication and/or a sidelink transmission that has lower priority relative to another sidelink communication and/or another sidelink transmission. Accordingly, the receive UE 704 may transmit a first sidelink communication that is linked to a first transmission occasion (e.g., scheduled to be transmitted in the first transmission occasion) that has a first priority relative to a second priority of a second transmission occasion, and/or the receive UE 704 may drop transmission of a second sidelink communication that is linked to the second transmission occasion.

In some aspects, a relative priority between sidelink communications may be based at least in part on a type of sidelink feedback communications, such as a relative priority in which a sidelink NACK feedback communication has higher priority relative to a sidelink ACK/NACK feedback communication as described above. Accordingly, the receive UE 704 may, in some scenarios, transmit a sidelink NACK feedback communication and drop a sidelink ACK/NACK feedback communication in a same time window. As one example, the receive UE 704 may drop the sidelink ACK/NACK feedback communication based at least in part on a current resource consumption satisfying a duty cycle resource threshold.

Alternatively, or additionally, a sidelink inter-channel prioritization may indicate a relative priority between sidelink channels, such as a relative priority that indicates that a PSSCH (e.g., a PSSCH communication) has higher priority than a PSFCH (e.g., a PSFCH communication), or vice versa. Accordingly, the receive UE 704 may transmit the PSSCH and drop transmission of the PSFCH in a same time window.

In some aspects, the sidelink inter-channel prioritization may indicate a relative priority between a PSSCH communication and inter-UE coordination conflict information, such as relative priority that indicates that a PSSCH communication has higher priority relative to inter-UE coordination conflict information, or vice versa. Alternatively, or additionally, the sidelink inter-channel prioritization may indicate a dropping rule that specifies which type of PSFCH communication to drop.

Accordingly, the receive UE 704 may transmit the sidelink feedback communication and/or may drop the inter-UE coordination conflict information in a same time window. In a similar manner as described above, the receive UE 704 may drop transmission of a PSFCH communication or other types of sidelink communications conditionally (e.g., based at least in part on a current resource consumption satisfying, or failing to satisfy, a duty cycle resource threshold).

In some aspects, and based at least in part on a condition being satisfied (e.g., a current resource consumption satisfying a duty cycle resource threshold), the receive UE 704 may drop a particular sidelink communication type for a remaining duration of a time window based at least in part on a condition being satisfied. That is, the receive UE 704 may not drop a sidelink transmission as indicated by a sidelink inter-channel prioritization rule (e.g., via a relative priority, a dropping rule, and/or a transmission occasion priority) for a first duration of the time window during which the condition is not satisfied, and may begin dropping transmission of one or more sidelink communications for a second duration (e.g., a remaining duration) of the time window during which the condition is satisfied.

A UE may use a sidelink inter-channel prioritization rule to determine whether to transmit or drop a sidelink communication, sometimes based at least in part on a condition being satisfied as described above. By selectively transmitting a sidelink communication based at least in part on a sidelink inter-channel prioritization, the UE may satisfy a sidelink access condition, such as a duty cycle condition, in a manner that reduces data transfer latencies and/or increases data throughput in sidelink communications.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with PSFCH prioritization.

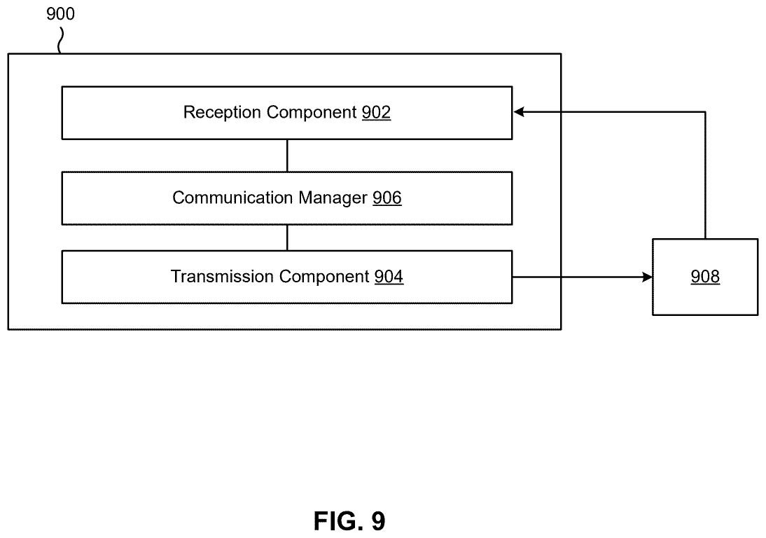

As shown in FIG. 8, in some aspects, process 800 may include receiving a transmission from a transmit UE (block 810). For example, the UE (e.g., using communication manager 906, depicted in FIG. 9) may receive a transmission from a transmit UE, as described above.

As further shown in FIG. 8, in some aspects, process 800 may include transmitting a sidelink communication selectively and based at least in part on a sidelink inter-channel prioritization rule (block 820). For example, the UE (e.g., using transmission component 904 and/or communication manager 906, depicted in FIG. 9) may transmit a sidelink communication selectively and based at least in part on a sidelink inter-channel prioritization rule, as described above.

Process 800 may include additional aspects, such as any single aspect or any combination of aspects described below and/or in connection with one or more other processes described elsewhere herein.

In a first aspect, transmitting the sidelink communication selectively includes transmitting the sidelink communication based at least in part on a priority indicated by the sidelink inter-channel prioritization rule.

In a second aspect, transmitting the sidelink communication selectively includes dropping transmission of the sidelink communication based at least in part on a priority indicated by the sidelink inter-channel prioritization rule.

In a third aspect, the sidelink communication is a first sidelink communication, and process 800 includes transmitting a second sidelink communication based at least in part on the priority indicating that the second sidelink communication has precedence over the first sidelink communication.

In a fourth aspect, the sidelink inter-channel prioritization rule indicates a relative priority between a first sidelink channel and a second sidelink channel.

In a fifth aspect, the first sidelink channel is a physical sidelink feedback channel, and the second sidelink channel is a physical sidelink shared channel.

In a sixth aspect, the sidelink inter-channel prioritization rule indicates that a PSSCH has priority over a PSFCH.

In a seventh aspect, the sidelink communication is a PSFCH communication, and transmitting the sidelink communication selectively includes dropping transmission of the PSFCH communication based at least in part on the sidelink inter-channel prioritization rule.

In an eighth aspect, transmitting the sidelink communication selectively includes transmitting the sidelink communication selectively based at least in part on a duty cycle resource threshold, and the sidelink inter-channel prioritization rule indicates a rule for dropping the sidelink communication.

In a ninth aspect, process 800 includes determining that a current resource consumption satisfies the duty cycle resource threshold, and transmitting the sidelink communication selectively includes dropping transmission of the sidelink communication based at least in part on the current resource consumption satisfying the duty cycle resource threshold.

In a tenth aspect, process 800 includes determining that a current resource consumption fails to satisfy the duty cycle resource threshold, and transmitting the sidelink communication selectively includes transmitting the sidelink communication based at least in part on the current resource consumption failing to satisfy the duty cycle resource threshold.

In an eleventh aspect, the sidelink inter-channel prioritization rule indicates a priority threshold, and transmitting the sidelink communication selectively includes transmitting the sidelink communication selectively based at least in part on whether a priority of a transmission occasion for the sidelink communication satisfies the priority threshold.

In a twelfth aspect, the priority of the transmission occasion satisfies the priority threshold, and transmitting the sidelink communication selectively includes transmitting the sidelink communication.

In a thirteenth aspect, the priority of the transmission occasion fails to satisfy the priority threshold, and transmitting the sidelink communication selectively includes dropping transmission of the sidelink communication.

In a fourteenth aspect, dropping the transmission of the sidelink communication is based at least in part on a current resource consumption satisfying a duty cycle resource threshold.

In a fifteenth aspect, the sidelink communication is a first sidelink communication that is associated with a first transmission occasion that has a first priority, a second sidelink communication is associated with a second transmission occasion that has a second priority, process 800 includes determining a transmission occasion priority based at least in part on the first priority and the second priority, and the sidelink inter-channel prioritization rule indicates to drop a lower priority transmission.

In a sixteenth aspect, transmitting the sidelink communication selectively includes transmitting the first sidelink communication selectively based at least in part on the transmission occasion priority.

In a seventeenth aspect, the transmission occasion priority indicates that the first priority is higher than the second priority, and transmitting the first sidelink communication selectively includes transmitting the first sidelink communication.

In an eighteenth aspect, the transmission occasion priority indicates that the first priority is lower than the second priority, and transmitting the first sidelink communication selectively includes dropping transmission of the first sidelink communication.

In a nineteenth aspect, the first sidelink communication is a PSFCH communication, and the second sidelink communication is a PSSCH communication.

In a twentieth aspect, the sidelink communication is a sidelink NACK feedback communication, and the sidelink inter-channel prioritization rule indicates that the sidelink NACK feedback communication has a higher priority relative to a sidelink ACK/NACK feedback communication.

In a twenty-first aspect, the sidelink communication is a PSFCH communication that indicates inter-UE coordination conflict information, and the sidelink inter-channel prioritization rule prioritizes dropping the inter-UE coordination conflict information instead of a PSSCH communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 6-7. Additionally, or alternatively, the apparatus 900 may be configured to perform one or more processes described herein, such as process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The communication manager 906 may receive a transmission from a transmit UE. The transmission component 904 may transmit a sidelink communication selectively and based at least in part on a sidelink inter-channel prioritization rule. In some aspects, the communication manager 906 may determine that a current resource consumption satisfies the duty cycle resource threshold. In other aspects, the communication manager 906 may determine that a current resource consumption fails to satisfy the duty cycle resource threshold.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a receive user equipment (UE), comprising: receiving a transmission from a transmit UE; and transmitting a sidelink communication selectively and based at least in part on a sidelink inter-channel prioritization rule.

Aspect 2: The method of Aspect 1, wherein transmitting the sidelink communication selectively comprises: transmitting the sidelink communication based at least in part on a priority indicated by the sidelink inter-channel prioritization rule.

Aspect 3: The method of any of Aspects 1-2, wherein transmitting the sidelink communication selectively comprises: dropping transmission of the sidelink communication based at least in part on a priority indicated by the sidelink inter-channel prioritization rule.

Aspect 4: The method of Aspect 3, wherein the sidelink communication is a first sidelink communication, and wherein the method further comprises: transmitting a second sidelink communication based at least in part on the priority indicating that the second sidelink communication has precedence over the first sidelink communication.

Aspect 5: The method of any of Aspects 1-4, wherein the sidelink inter-channel prioritization rule indicates a relative priority between a first sidelink channel and a second sidelink channel.

Aspect 6: The method of Aspect 5, wherein the first sidelink channel is a physical sidelink feedback channel, and wherein the second sidelink channel is a physical sidelink shared channel.

Aspect 7: The method of any of Aspects 1-6, wherein the sidelink inter-channel prioritization rule indicates that a physical sidelink shared channel (PSSCH) has priority over a physical sidelink feedback channel (PSFCH).

Aspect 8: The method of Aspect 7, wherein the sidelink communication is a PSFCH communication, and wherein transmitting the sidelink communication selectively comprises: dropping transmission of the PSFCH communication based at least in part on the sidelink inter-channel prioritization rule.

Aspect 9: The method of any of Aspects 1-8, wherein transmitting the sidelink communication selectively comprises: transmitting the sidelink communication selectively based at least in part on a duty cycle resource threshold, wherein the sidelink inter-channel prioritization rule indicates a rule for dropping the sidelink communication.

Aspect 10: The method of Aspect 9, further comprising: determining that a current resource consumption satisfies the duty cycle resource threshold, wherein transmitting the sidelink communication selectively comprises: dropping transmission of the sidelink communication based at least in part on the current resource consumption satisfying the duty cycle resource threshold, wherein transmitting the sidelink communication selectively comprises: dropping transmission of the sidelink communication based at least in part on the current resource consumption satisfying the duty cycle resource threshold.

Aspect 11: The method of Aspect 9, further comprising: determining that a current resource consumption fails to satisfy the duty cycle resource threshold, wherein transmitting the sidelink communication selectively comprises: transmitting the sidelink communication based at least in part on the current resource consumption failing to satisfy the duty cycle resource threshold, wherein transmitting the sidelink communication selectively comprises: transmitting the sidelink communication based at least in part on the current resource consumption failing to satisfy the duty cycle resource threshold.

Aspect 12: The method of any of Aspects 1-11, wherein the sidelink inter-channel prioritization rule indicates a priority threshold, wherein transmitting the sidelink communication selectively comprises: transmitting the sidelink communication selectively based at least in part on whether a priority of a transmission occasion for the sidelink communication satisfies the priority threshold.

Aspect 13: The method of Aspect 12, wherein the priority of the transmission occasion satisfies the priority threshold, and wherein transmitting the sidelink communication selectively comprises: transmitting the sidelink communication.

Aspect 14: The method of Aspect 12, wherein the priority of the transmission occasion fails to satisfy the priority threshold, and wherein transmitting the sidelink communication selectively comprises: dropping transmission of the sidelink communication.

Aspect 15: The method of Aspect 14, wherein dropping the transmission of the sidelink communication is based at least in part on a current resource consumption satisfying a duty cycle resource threshold.

Aspect 16: The method of any of Aspects 1-15, wherein the sidelink communication is a first sidelink communication that is associated with a first transmission occasion that has a first priority, wherein a second sidelink communication is associated with a second transmission occasion that has a second priority, and wherein the method further comprises: determining a transmission occasion priority based at least in part on the first priority and the second priority, wherein the sidelink inter-channel prioritization rule indicates to drop a lower priority transmission.

Aspect 17: The method of Aspect 16, wherein transmitting the sidelink communication selectively comprises: transmitting the first sidelink communication selectively based at least in part on the transmission occasion priority.

Aspect 18: The method of Aspect 17, wherein the transmission occasion priority indicates that the first priority is higher than the second priority, and wherein transmitting the first sidelink communication selectively comprises: transmitting the first sidelink communication.

Aspect 19: The method of Aspect 17, wherein the transmission occasion priority indicates that the first priority is lower than the second priority, and wherein transmitting the first sidelink communication selectively comprises: dropping transmission of the first sidelink communication.

Aspect 20: The method of Aspect 16, wherein the first sidelink communication is a physical sidelink feedback channel (PSFCH) communication, and wherein the second sidelink communication is a physical sidelink shared channel (PSSCH) communication.

Aspect 21: The method of any of Aspects 1-20, wherein the sidelink communication is a sidelink negative acknowledgement (NACK) feedback communication, and wherein the sidelink inter-channel prioritization rule indicates that the sidelink NACK feedback communication has a higher priority relative to a sidelink acknowledgement (ACK)/NACK feedback communication.

Aspect 22: The method of any of Aspects 1-21, wherein the sidelink communication is a physical sidelink feedback channel (PSFCH) communication that indicates inter-UE coordination conflict information, and wherein the sidelink inter-channel prioritization rule prioritizes dropping the inter-UE coordination conflict information instead of a physical sidelink shared channel (PSSCH) communication.

Aspect 23: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-22.

Aspect 24: An apparatus for wireless communication at a device, the apparatus comprising one or more memories and one or more processors coupled to the one or more memories, the one or more processors configured to cause the device to perform the method of one or more of Aspects 1-22.

Aspect 25: An apparatus for wireless communication, the apparatus comprising at least one means for performing the method of one or more of Aspects 1-22.

Aspect 26: A non-transitory computer-readable medium storing code for wireless communication, the code comprising instructions executable by one or more processors to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

Aspect 28: A device for wireless communication, the device comprising a processing system that includes one or more processors and one or more memories coupled with the one or more processors, the processing system configured to cause the device to perform the method of one or more of Aspects 1-22.

Aspect 29: An apparatus for wireless communication at a device, the apparatus comprising one or more memories and one or more processors coupled to the one or more memories, the one or more processors individually or collectively configured to cause the device to perform the method of one or more of Aspects 1-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a receive user equipment (UE), comprising:
one or more memories; and
one or more processors, coupled to the one or more memories, configured to cause the UE to:
receive a transmission from a transmit UE; and
transmit a sidelink communication selectively and based at least in part on a sidelink inter-channel prioritization rule.

2. The apparatus of claim 1, wherein the one or more processors, to cause the UE to transmit the sidelink communication selectively, are configured to cause the UE to:
transmit the sidelink communication based at least in part on a priority indicated by the sidelink inter-channel prioritization rule.

3. The apparatus of claim 1, wherein the one or more processors, to cause the UE to transmit the sidelink communication selectively, are configured to cause the UE to:
drop transmission of the sidelink communication based at least in part on a priority indicated by the sidelink inter-channel prioritization rule.

4. The apparatus of claim 3, wherein the sidelink communication is a first sidelink communication, and
wherein the one or more processors are further configured to cause the UE to:
transmit a second sidelink communication based at least in part on the priority indicating that the second sidelink communication has precedence over the first sidelink communication.

5. The apparatus of claim 1, wherein the sidelink inter-channel prioritization rule indicates a relative priority between a first sidelink channel and a second sidelink channel.

6. The apparatus of claim 1, wherein the sidelink inter-channel prioritization rule indicates that a physical sidelink shared channel (PSSCH) has priority over a physical sidelink feedback channel (PSFCH).

7. The apparatus of claim 1, wherein the one or more processors, to cause the UE to transmit the sidelink communication selectively, are configured to cause the UE to:
transmit the sidelink communication selectively based at least in part on a duty cycle resource threshold, wherein the sidelink inter-channel prioritization rule indicates a rule for dropping the sidelink communication.

8. The apparatus of claim 1, wherein the sidelink inter-channel prioritization rule indicates a priority threshold, and
wherein the one or more processors, to cause the UE to transmit the sidelink communication selectively, are configured to cause the UE to:
transmit the sidelink communication selectively based at least in part on whether a priority of a transmission occasion for the sidelink communication satisfies the priority threshold.

9. The apparatus of claim 1, wherein the sidelink communication is a first sidelink communication that is associated with a first transmission occasion that has a first priority,
wherein a second sidelink communication is associated with a second transmission occasion that has a second priority, and
wherein the one or more processors are further configured to cause the UE to:
determine a transmission occasion priority based at least in part on the first priority and the second priority,
wherein the sidelink inter-channel prioritization rule indicates to drop a lower priority transmission.

10. The apparatus of claim 1, wherein the sidelink communication is a sidelink negative acknowledgement (NACK) feedback communication, and
wherein the sidelink inter-channel prioritization rule indicates that the sidelink NACK feedback communication has a higher priority relative to a sidelink acknowledgement (ACK)/NACK feedback communication.

11. The apparatus of claim 1, wherein the sidelink communication is a physical sidelink feedback channel (PSFCH) communication that indicates inter-UE coordination conflict information, and
wherein the sidelink inter-channel prioritization rule prioritizes dropping the inter-UE coordination conflict information instead of a physical sidelink shared channel (PSSCH) communication.

12. A method of wireless communication performed by a receive user equipment (UE), comprising:
receiving a transmission from a transmit UE; and
transmitting a sidelink communication selectively and based at least in part on a sidelink inter-channel prioritization rule.

13. The method of claim 12, wherein transmitting the sidelink communication selectively comprises:
transmitting the sidelink communication based at least in part on a priority indicated by the sidelink inter-channel prioritization rule.

14. The method of claim 12, wherein transmitting the sidelink communication selectively comprises:
dropping transmission of the sidelink communication based at least in part on a priority indicated by the sidelink inter-channel prioritization rule.

15. The method of claim 12, wherein transmitting the sidelink communication selectively comprises:
transmitting the sidelink communication selectively based at least in part on a duty cycle resource threshold, wherein the sidelink inter-channel prioritization rule indicates a rule for dropping the sidelink communication.

16. The method of claim 15, further comprising:
determining that a current resource consumption satisfies the duty cycle resource threshold,
wherein transmitting the sidelink communication selectively comprises:
dropping transmission of the sidelink communication based at least in part on the current resource consumption satisfying the duty cycle resource threshold.

17. The method of claim 15, further comprising:
determining that a current resource consumption fails to satisfy the duty cycle resource threshold,
wherein transmitting the sidelink communication selectively comprises:
transmitting the sidelink communication based at least in part on the current resource consumption failing to satisfy the duty cycle resource threshold.

18. A non-transitory computer-readable medium storing a set of instructions for wireless communication, the set of instructions comprising:
one or more instructions that, when executed by one or more processors of a receive user equipment (UE), cause the UE to:
receive a transmission from a transmit UE; and
transmit a sidelink communication selectively and based at least in part on a sidelink inter-channel prioritization rule.

19. The non-transitory computer-readable medium of claim 18, wherein the one or more instructions, that cause the UE to transmit the sidelink communication selectively, cause the UE to:
transmit the sidelink communication based at least in part on a priority indicated by the sidelink inter-channel prioritization rule.

20. The non-transitory computer-readable medium of claim 18, wherein the one or more instructions, that cause the UE to transmit the sidelink communication selectively, cause the UE to:
drop transmission of the sidelink communication based at least in part on a priority indicated by the sidelink inter-channel prioritization rule.
